(19) United States
(12) Patent Application Publication
(10) Pub. No.: US 2012/0242064 A1
(43) Pub. Date: Sep. 27, 2012

(54) VEHICLE STEERING WHEEL

(76) Inventors: Steffen Weigand, Aschaffenburg (DE); Andreas Hans, Aschaffenburg (DE); Thomas Hofmann, Aschaffenburg (DE)

(21) Appl. No.: 13/514,570

(22) PCT Filed: Dec. 6, 2010
(86) PCT No.: PCT/EP10/68939

§ 371 Date: Jun. 7, 2012

(30) Foreign Application Priority Data
Dec. 8, 2009 (DE) 10 2009 047 690.3

(51) Int. Cl. B60R 21/203

(52) U.S. Cl. 280/728.2

(57) ABSTRACT

A vehicle steering is provided having a steering wheel skeleton, which is at least partially coated with steering wheel foam and which includes a steering wheel rim and multiple steering wheel spokes, an air bag module, including a module casing and a module cover, the module cover faces a driver of a vehicle when the steering wheel is installed in the vehicle, electrical contact means to trigger a vehicle horn, fastening means designed on the module casing for the floating bearing of the module casing on the steering wheel, and pivoting means, which are designed on the module casing and are arranged spaced apart from the fastening means. The module casing can be pivoted relative to the steering wheel skeleton, and the electrical contact means are closed upon pivoting the module casing. The pivoting means, designed on the module casing, are mounted in the steering wheel foam of the steering wheel.

The invention relates to a vehicle steering wheel according to the preamble of claim 1,

It is known to integrate an air bag module into a steering wheel of a vehicle. Therein it has to be ensured that the driver of the vehicle can trigger a vehicle horn by pressing a cover, located in the middle of the steering wheel.

For the realization of a horn function in steering wheels with integrated air bag modules, solutions with floatingly mounted air bag modules are known, in which upon pressurization the air bag module is axially deflected altogether. The disadvantages of the solutions with floatingly mounted air bag modules are that the impact forces are relatively high and the necessary actuating path relatively large.

From WO 2005/080143 A1 a vehicle steering wheel is known, having hinging means for the pivotable mounting of the module casing of an air bag module on the steering wheel. A point of support of the air bag module is locked in place on the steering wheel skeleton and serves as centre of rotation for a pivoting of the module casing. This solution, however, cannot be realized in every design for lack of space and is relatively complex, because three connections to the steering wheel skeleton are needed. Rattling noises can also occur.

From EP 1 834 844 A2 a vehicle steering wheel is known, in which an air bag module has a cover cap and a module casing and the cover cap of the air bag module is locked in place in the area of the steering wheel rim in the steering wheel foam and is designed pivotable around this locking engagement for triggering a horn function. The module casing is not connected to the steering wheel skeleton.

Based on this prior art, the object underlying the present invention is to provide a vehicle steering wheel with integrated air bag module which allows for the triggering of a horn function in a simple and flexible manner.

This object is achieved according to the invention by a vehicle steering wheel with the features of claim 1. Embodiments of the invention are mentioned in the sub-claims.

According to this, the solution according to the invention is characterized by the technical teaching to arrange and mount pivoting means designed on the module casing, around which the module casing can be pivoted relative to the steering wheel skeleton, in the steering wheel foam of the steering wheel in an air bag module that is integrated into a steering wheel and comprises a module casing and a module cover. The mounting of the module casing is thus provided not on the steering wheel skeleton, but instead in the steering wheel foam.

The solution according to the invention comes in connection with a plurality of advantages. It is cost-effective because a bearing in the steering wheel foam can be provided in a simple and cost-effective manner upon producing the foam casing of the steering wheel skeleton. At the same time it allows for a mounting of a module casing on a steering wheel in a flexible manner, because by a suitable design of the steering wheel foam, areas can be provided in a flexible manner, which can serve a pivotable mounting of the module casing. For example, it is possible without any difficulties to provide separately formed foam parts on a steering wheel spoke, in which one or multiple bearings for the pivoting means are formed. It can equally be provided to provide, in the area of the steering wheel hub; a foam part or a foam area for the mounting of the pivoting means.

A further advantage of the present invention is that the module casing can be fastened to the steering wheel in an area turned away from a driver and close to the steering wheel base. This is the case on account of the formation of the pivoting means on the module casing itself. In this way, the pivoting means can for example be designed on the module casing, on its lower side turned away from a driver, and be mounted in the steering wheel foam. Mounting the module casing in an area that is turned away from a driver and close to the steering wheel base is further supported, when the module casing is mounted in the steering wheel foam, in the area of at least one spoke of the steering wheel skeleton or in the area of the steering wheel hub. This mounting, turned away from a driver and the steering wheel rim, allows to keep the steering wheel rim free of corresponding bearing means and for other elements such as control elements.

A preferred provided mounting of the module casing in the area of the steering wheel spokes or in the area of the steering wheel hub has, furthermore, the advantage that due to the kinematics the actuating forces for triggering a honking process and, correspondingly, the gap dimensions between the air bag module and the steering wheel can be minimized. The radial distance between the at least one swivel axis and the contact means for triggering a vehicle horn becomes all the smaller here on account of the taper of the steering wheel from the steering wheel rim towards the steering wheel hub, the further the swivel axis is spaced apart from the steering wheel rim and constructed in the direction of the steering wheel hub. Here, the rule applies that the smaller this radial distance, the less is also the pivoting of the air bag module, which said air bag module undergoes upon a honking process, so that the gap dimensions between the air bag module and the steering wheel can further be minimized.

In an embodiment of the present invention it is provided that the pivoting means allow for a pivoting movement of the module casing along exactly one swivel axis. The pivoting of the module casing around an axis in the steering wheel foam makes it possible to further simplify and minimize the kinematics for triggering a horn function. A pivoting around only one axis furthermore has the advantage that an air bag cover or cap, connected to or placed upon the module casing, is pivoted on its edges only a minimal path relative to the steering wheel, so that the corresponding gap dimensions in turn can be minimized.

For realizing a pivoting movement of the module casing along exactly one swivel axis it is provided in an exemplary embodiment that the swivel axis is formed by at least two fastening elements, lying on one axis, which are spaced apart from each other and can be rotated in the steering wheel foam around this axis. The fastening elements are for example cylindrical stub shafts or ball heads designed on the module casing and are, for example, projecting with respect to the actual module casing, so that they can be mounted in the steering wheel foam. It can likewise be provided that the fastening elements are elements which can be connected lockable to the steering wheel foam. For example, they can be conventional locking pins.

The steering wheel foam according to the invention forms at least one bearing housing for mounting the pivoting means designed on the module casing. Here it can be provided that the steering wheel foam is formed, at least in the area of the bearing housing, by a separate foam part, for example designed on at least one of the spokes or in the area of the steering wheel hub of the steering wheel. The foam part can be adapted to the design of the module casing and ensure that in each module casing design mounting the module casing in the steering wheel foam is possible in a simple manner. While the foam part in this case is a part with a separate design, it is, however, preferably manufactured with the foam casing of the steering wheel.

It is possible here that such a foam part extends in the area of one spoke or perhaps extends between two adjacent spokes. It can also be provided that a spoke has struts spaced apart from each other, between which such a foam part extends. Such a foam part can equally extend in the area of the steering wheel base.

In a further embodiment of the invention the fastening means have at least two fastening pins, arranged along an axis, which runs parallel to the swivel axis. The floating bearing of the module casing in the steering wheel, provided by means of the fastening means as well as by suitably arranged spring means, is here such that upon pivoting the module casing relative to the steering wheel skeleton the fastening means in form of the at least two fastening pins are pivoted in the same manner within the scope of the tolerance provided by the floating bearing. This allows for constructing the fastening pins in the same manner and to connect them to the steering wheel.

In a further embodiment the fastening means can be locked in place with the steering wheel so that the air bag module can be assembled on the steering wheel in a simple manner. A locking process of the fastening means takes place here in an embodiment in the area of the steering wheel hub of the steering wheel.

For the already mentioned floating bearing of the module casing on the steering wheel at least one spring element is provided, which rests between the module casing and the steering wheel hub or a part connected to said module casing, and which provides a spring force loaded tolerance for the movement of the module casing relative to the steering wheel. This spring force loaded tolerance allows for a pivoting of the module casing according to the invention around the mounting provided in the area of at least one steering wheel spoke in the steering wheel foam of the spoke.

The air bag module has a module cover or cap, which faces a driver of a vehicle when the steering wheel is installed in the vehicle. The module cover is that part of the air bag module, onto which the driver exerts manual pressure to trigger a horn function. As the module cover is connected to the module casing, this pressure is transferred onto the module casing and is there converted into a pivoting movement. The module cover itself, however, is, according to the invention, not directly connected to the steering wheel and has particularly no fastening or locking engagement in the steering wheel foam. The pivoting means, mounted in the steering wheel foam of the steering wheel, are designed on the module casing, but not on the module cover.

The pivoting means designed on the module casing are in an embodiment formed in one piece with the module casing and designed as protrusions. For example, the module casing including the pivoting means is manufactured as an injection moulded part. Instead of being formed in one piece, it can, however, basically also be provided that the pivoting means are manufactured as separate parts and are connected to the module casing for example by screwing or welding together.

The electrical contact means, which trigger a vehicle horn, are in an embodiment of the invention arranged on the module casing on the side that is turned away from a driver of the vehicle. Upon pivoting the module casing the electrical contact means are closed, so that the horn function is triggered.

In a further embodiment the pivoting means are arranged and mounted in the steering wheel foam via snap fits.

The invention will subsequently be further explained referring to the figures of the drawing with the help of an exemplary embodiment. In the figures:

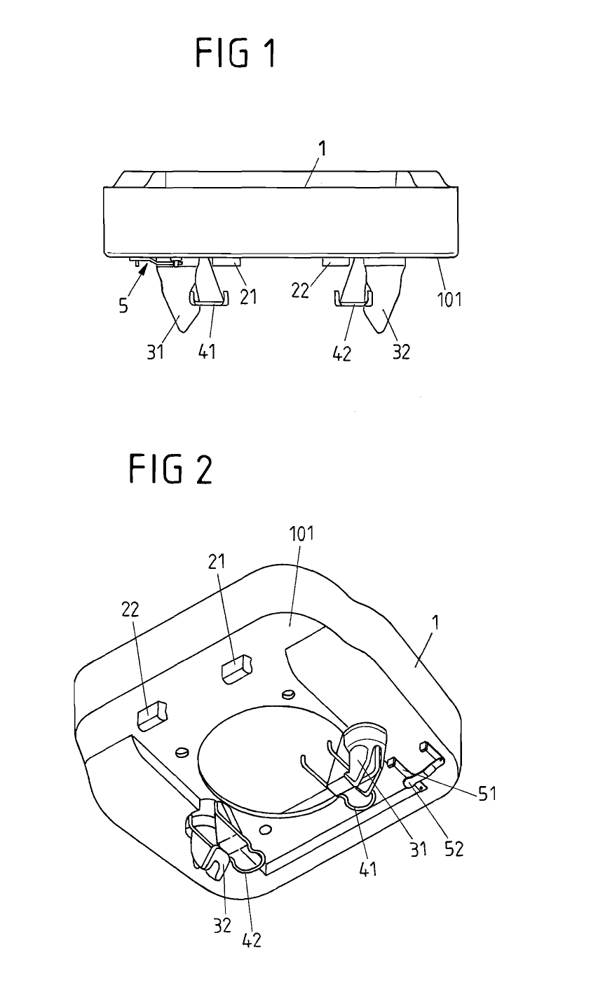

FIG. 1 shows a side view of an exemplary embodiment of a module casing of an air bag module, integrated into a steering wheel;

FIG. 2 shows a perspective view of the module casing of FIG. 1 from a diagonal low angle perspective;

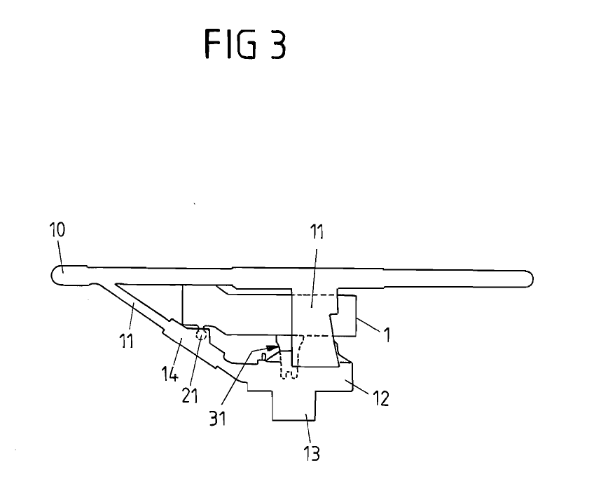

FIG. 3 shows a side view of the module casing of FIGS. 1 and 2, wherein the module casing is fastened pivotable in a vehicle steering wheel;

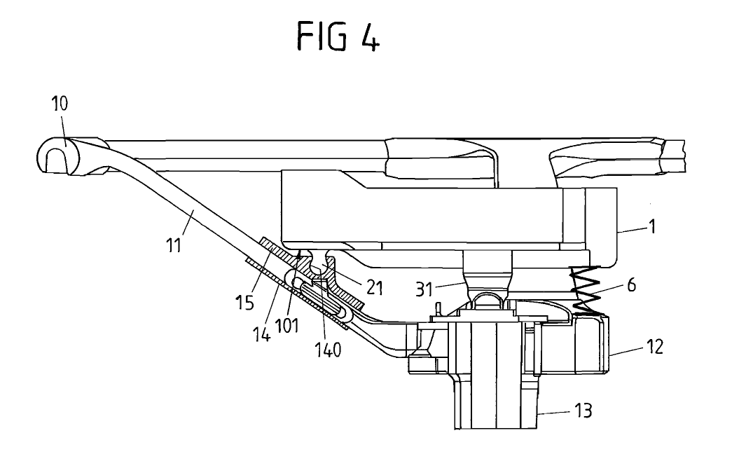

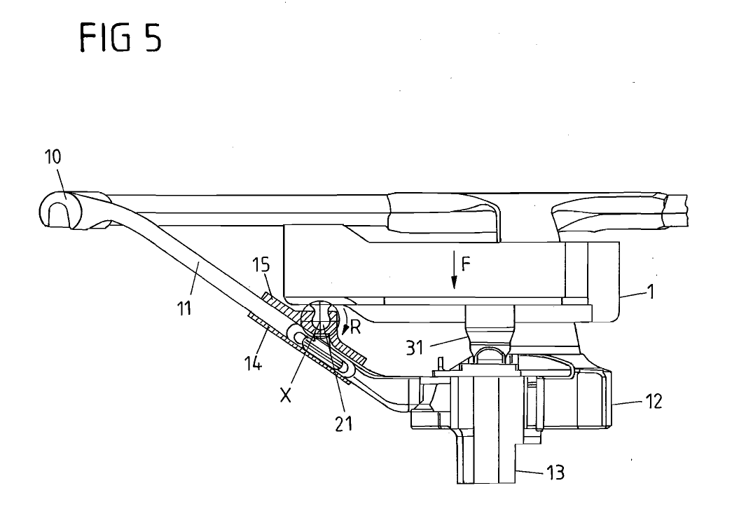

FIG. 4 shows a more detailed illustration of the arrangement of FIG. 3;

FIG. 5 shows the arrangement of FIG. 4, wherein additionally a swivel axis and a pivoting direction for pivoting the module casing relative to the steering wheel is illustrated;

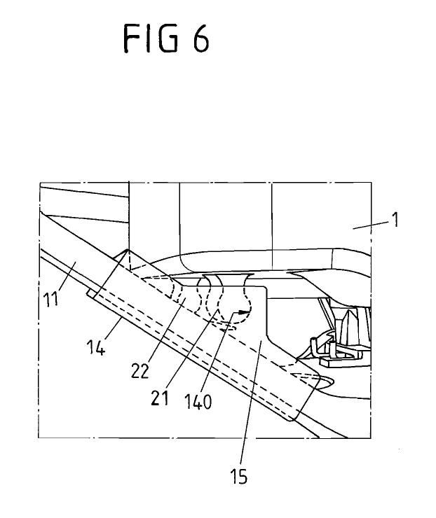

FIG. 6 shows a detailed illustration of the arrangement of FIG. 5, wherein the pivotable mounting of the module casing in the steering wheel foam of the spoke is illustrated magnified;

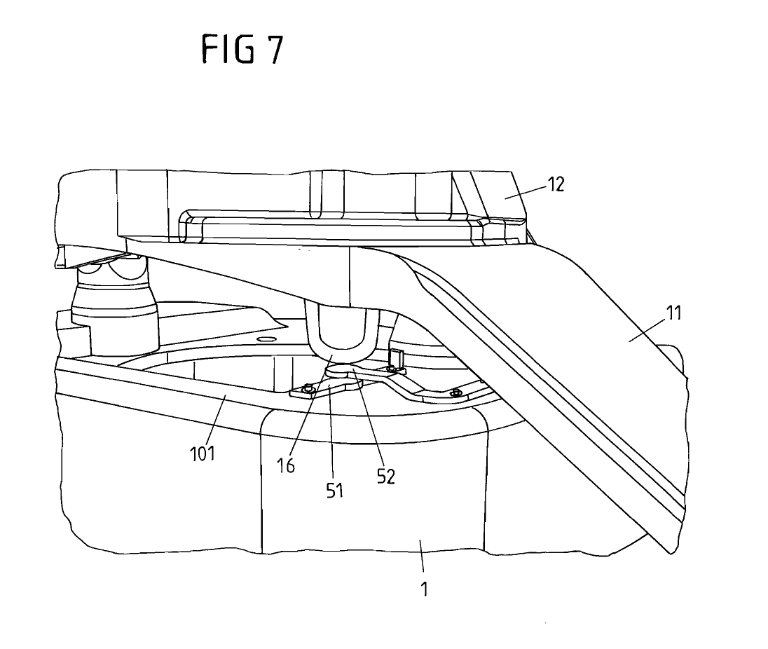

FIG. 7 shows an illustration of the electrical contact means of the steering wheel for triggering a vehicle horn;

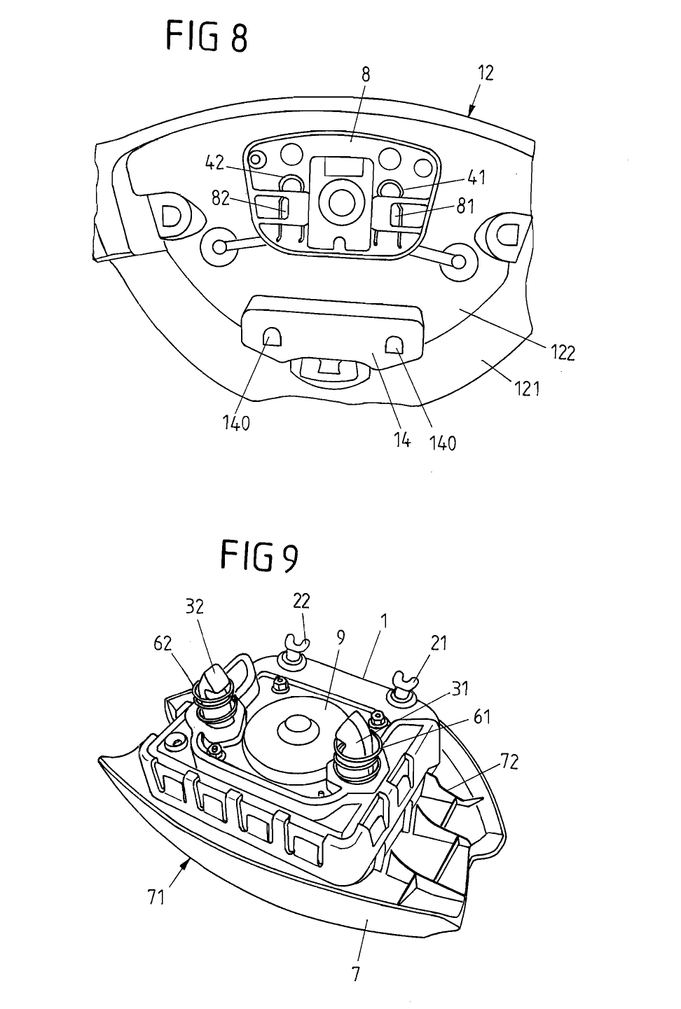

FIG. 8 shows a perspective view of the vehicle hub of a further exemplary embodiment of a steering wheel; and

FIG. 9 shows a perspective view of an air bag module of the further exemplary embodiment.

FIG. 1 shows a module casing 1 of an air bag module, integrated into a steering wheel. Any structure of an air bag module is here designated as module casing which serves the fastening and/or housing of a gas generator and/or of an air bag of the air bag module.

For example, a module casing as defined by the present invention also comprises a gas generator support, which serves the arrangement and fastening of a gas generator of the air bag module. A module casing equally designates a casing in which or onto which an air bag of the air bag module is arranged. A module casing can also serve both the arrangement of an air bag and the fastening of a gas generator.

In FIG. 1 an air bag and a gas generator of the air bag module are not separately illustrated. Conventional gas generators and air bag arrangements as such, known in prior art, can be used in connection with the illustrated module casing.

Likewise not illustrated in FIG. 1 is a module cover or cap, which faces the driver when the steering wheel is installed in a vehicle and which is impacted with pressure for triggering a honking process by the driver. Such a cover is rigidly connected to the module casing 1 illustrated in FIG. 1, but not to other parts of the vehicle steering wheel.

The module casing 1 is essentially designed rectangular in the illustrated exemplary embodiment, as can also be seen in the illustration of FIG. 2. Such a rectangular form is merely to be understood as an example. For example, a curved or polygonal shape can equally be provided.

The module casing 1 has fastening means 31, 32 formed by two fastening pins, which protrude from the lower side 101 of the module casing 1. The lower side 101 of the module casing here is that side which is turned away from the driver, when the air bag module is installed in a steering wheel. The fastening means 31, 32 serve the floating bearing of the module casing 1 on the steering wheel and in the area of the steering wheel hub of the steering wheel, as will yet be seen with the help of FIGS. 3 to 5. For the floating bearing, furthermore, spring elements (not illustrated in FIGS. 1 and 2) are provided, which provide a spring force loaded tolerance for the movement of the module casing 1 relative to the steering wheel within the scope of a pivoting movement of the module casing 1.

As illustrated in FIG. 2, to each of the fastening pins 31, 32 a metal clip 41, 42 is allocated, having two clip arms, by means of which the pin 31, 32 can be locked in place in corresponding recesses of a steering wheel hub. The metal clips 41, 42 are in this case pre-assembled in the steering wheel skeleton and hold the air bag module in the steering wheel upon assembly.

The module casing 1 furthermore has pivoting means in the form of two fastening and mounting protrusions 21, 22, which protrude from the lower side 101 of the module casing 1. The fastening and mounting protrusions 21, 22 are arranged along a swivel axis. Both fastening pins 31, 32 are also arranged along an axis. Both axes run parallel to each other here.

On the lower side 101 of the module casing 1 electrical contact means 5 are furthermore arranged, which are formed by a lower contact 51, fastened to the module casing, and an upper contact 52, which can be moved relative to said lower contact 51.

FIG. 3 shows schematically and without the illustration of details the arrangement of a module casing 1 according to FIGS. 1 and 2 in a vehicle steering wheel. The steering wheel has in a familiar manner as such a steering wheel rim 10, multiple steering wheel spokes 11 (three in the illustrated exemplary embodiment) and a steering wheel hub 12, which can also be designated as the steering wheel base or steering wheel canister. In the area of the steering wheel hub 12 a coupling piece 13 is located to connect the steering wheel to a steering shaft (not illustrated).

The steering wheel has in a familiar manner as such a steering wheel skeleton, which is at least partially coated with steering wheel foam. Typically, the steering wheel rim 10 and parts of the steering wheel spokes 11 are coated with steering wheel foam. In the illustrated exemplary embodiment one of the steering wheel spokes 11 has a foam part 14 surrounding the steering wheel spoke 11 in a lower area and spaced apart from the steering wheel rim 10. The steering wheel foam of this foam part 14 forms a bearing housing for the rotary mounting of the fastening and mounting protrusions 21, 22 of the module casing 1 illustrated in FIGS. 1 and 2. In the side view illustration of FIG. 3 one of the protrusions 21 is illustrated.

Likewise illustrated in FIG. 3 is one of the fastening pins 31, which is, lockable and therein floatingly mounted, connected to the steering wheel hub 12.

FIG. 4 shows the arrangement of FIG. 3 with the illustration of additional details. It can be seen that the steering wheel foam 15 is designed in a foam part 14 in that area, in which the steering wheel foam 15 provides a bearing for the pivoting means 21, 22 of the module casing 1. It is, however, pointed out that providing the bearing in a separate foam part 14 is only to be understood as an example. The bearing, formed in the steering wheel foam 15, can equally be designed in a foam area, which is designed continuous with the steering wheel foam 15 of the steering wheel.

The steering wheel foam 15 provides bearing housings 140 for housing the fastening and mounting protrusions 21, 22 of the module casing 1. The protrusions 21, 22 of the module casing 1 are locked into these bearing housings 140 by means of snap fits. The bearing is here in one embodiment designed as axial and radial bearing, in another embodiment merely as radial bearing.

The protrusions 21, locked into the steering wheel foam 15, have such a shape that the lower side 101 of the module casing 1, upon pivoting the module casing 1, essentially remains unchanged in its vertical position in the area of the protrusions 21, 22 and merely rotates. For this purpose the protrusions 21, 22 are designed, for example, circular in cross section, e.g. as stub shafts, i.e. as protrusions of a specific length with a cylindrical shape. It is likewise possible, for example, to design the protrusions 21, 22 as ball heads. As two protrusions 21, 22 are provided, it is in any case guaranteed and ensured that a rotation of the module casing 1 around the bearing 140, 21, 22 is possible along only one axis.

In FIG. 4 a spring element 6 furthermore is schematically illustrated. The spring element 6 serves to provide a floating bearing of the module casing on the steering wheel. The spring element 6 provides a spring force loaded tolerance for the axial movement of the module casing 1 relative to the steering wheel hub 12. In an embodiment two spring elements 6 are provided, corresponding to the number of the fastening pins 31, 32. The spring elements 6 can here be arranged coaxial, adjacent to or also spaced apart from the fastening pins. They can be especially effectively employed when they, corresponding to the illustration of FIG. 4, attach onto that end of the module casing 1, which is lying opposite to the end that forms the protrusions 21, 22.

The rotation of the module casing 1 around the bearing 140, 21, 22 along an axis is further illustrated in FIG. 5, which additionally indicates the swivel axis X and a pivoting direction R. Apart from that, the illustration of FIG. 5 corresponds to the illustration of FIG. 6, wherein, however, the spring 6, illustrated schematically in FIG. 4, is not illustrated.

In the case of an exertion of pressure by a driver onto a module cover or cap (not illustrated), connected to the module casing, the module casing 1 undergoes a force F in axial direction. This force F leads, contrary to the spring force provided by the spring elements, to a pivoting of the module casing 1 along the arrow R around the swivel axis X. Thereby, as will yet be explained with reference to FIG. 7, the electric contacts for triggering a vehicle horn are closed, so that a honking process is triggered. The specified solution allows the creation of a honking process while providing minimal kinematics between the module casing 1 and the motor vehicle steering wheel and minimal gap dimensions between the air bag module and the steering wheel.

After completing the pressurization, the electric contacts are interrupted by the restoring forces of the spring elements and the thus resulting pivoting back of the module casing 1 around the swivel axis X, and the horn signal expires.

FIG. 6 shows a slightly perspective detailed view of the mounting of the module casing 1 in the vehicle foam 15, wherein both fastening and mounting protrusions 21, 22 and corresponding bearing housings 140 in the vehicle foam 15 are illustrated. The fastening and mounting protrusions 21, 22 are mounted via snap fits in the steering wheel foam 15. This is possible because the steering wheel foam 15 has elastic properties.

The steering wheel foam 15 is formed in an exemplary embodiment by a permanently elastic flexible foam for example made of polyurethane.

FIG. 7 shows the closing of the electrical contact means 5 to trigger a horn function. For this purpose, a projecting pin 16 is designed on the steering wheel hub 12. The pin 16 can be coated with foam to achieve an insulation against the skeleton. Upon pivoting the module casing 1 on account of a pressurization, the projecting pin 16 presses the upper contact 52 against the lower contact 51, such that an electrical circuit is closed and a horn signal is triggered.

FIGS. 8 and 9 show a further exemplary embodiment of a steering wheel, wherein FIG. 8 illustrates the steering wheel hub 12 of the steering wheel and FIG. 9 illustrates an air bag module, which is to be assembled on the steering wheel hub 12.

The steering wheel hub 12 has a bottom area 122 and a wall 121 surrounding said bottom area 122, so that the steering wheel hub 12 is designed like a canister and provides a capacity for housing an air bag module. It will be designated steering wheel canister 12 below.

In the 6 o'clock position of the steering wheel and adjacent to the wall 121 a foam part 14 is arranged in the steering wheel canister 12 which serves, as described in reference to FIGS. 1 to 7, the mounting of pivoting means of the module casing. The foam part 14 has for this purpose two bearing housings 140 corresponding to the bearing housings 140 of FIG. 4 for housing fastening and mounting protrusions 21, 22 of the module casing.

The foam part 14 can be designed in one piece with the remaining steering wheel foam of the steering wheel or as a separate part. It rests, for example, on the steering wheel canister 12 and/or is fastened onto said steering wheel canister 12 e.g. via adhesive means. It can also be provided that the foam part additionally or alternatively rests on an adjacent spoke. It is here pointed out that an arrangement of the foam part 14 corresponding to FIG. 8 can also take place in or on the steering wheel canister 12 in case no spoke is provided adjacent to the foam part 14, for example in a 6 o'clock-arrangement of the foam part 14 in connection with a 4-spokes-steering wheel.

FIG. 8 shows, furthermore, a plate 8, preferably made of metal and fastened in the bottom area 122 of the steering wheel canister 14. Two metal clips or steel catch springs 41, 42 are clipped onto the plate 8. Thereby, lock openings 81, 82 are produced, into which fastening pins 31, 32 of the module casing 1 can be locked upon assembly of the module casing.

FIG. 9 shows an air bag module with a module casing 1, which essentially corresponds to the module casing 1 of FIGS. 1 to 7. Identical reference signs designate identical or corresponding parts. Additionally, a cover or cap 7 that is rigidly connected to the module casing 1, is illustrated. The cap 7 has an actuating surface 71 facing the driver in the assembled state. The cap further has reinforcing fins 72 to enhance the structural integrity of the cap 7. In FIG. 9, furthermore, the bottom plate 9 of a gas generator of the air bag module can be seen.

As with the module casing of FIGS. 1 to 7 two fastening and mounting protrusions 21, 22 are provided as pivoting means, which are designed on the module casing 1.

Allocated to the fastening pins 31, 32 for the floating bearing of the module casing 1 on the steering wheel are two spring elements 61, 62, which are arranged around the fastening pins 31, 32, i.e. coaxial to these.

Upon assembling the air bag module, the fastening and mounting protrusions 21, 22 snap into the bearing housings 140 of the foam part 14 of FIG. 8. Furthermore, the fastening pins 31, 32 can be locked in place by means of the metal clips 41, 42 in the lock openings 81, 82 of the plate 8 of the bottom area 122. In the case of an exertion of pressure by the driver onto the actuating surface 71 of the module cover 7, the module casing 1, as specified referring to FIGS. 4 and 5, undergoes a force in axial direction, which leads to a pivoting of the module casing around a swivel axis, which is formed by the fastening and mounting protrusions 21, 22 and the bearing housings 140.

The invention is in its embodiment not restricted to the exemplary embodiments illustrated above, which are to be understood merely as examples. For example, the module casing as well as its pivoting means can be designed in another manner and can be arranged and mounted in another manner in the vehicle foam of the steering wheel.

1. A vehicle steering wheel, comprising:
a steering wheel skeleton, which is at least partially coated with steering wheel foam and which comprises a steering wheel rim and multiple steering wheel spokes,
an air bag module, integrated into the steering wheel, comprising a module casing and a module cover, wherein the module casing serves to fasten and/or house a gas generator and/or an air bag of the air bag module, and the module cover faces a driver of a vehicle when the steering wheel is installed in the vehicle,
electrical contact means to trigger a vehicle horn,
fastening means, designed on the module casing, for the floating bearing of the module casing on the steering wheel, and
pivoting means, which are designed on the module casing and are arranged spaced apart from the fastening means, wherein the module casing can be pivoted relative to the steering wheel skeleton and the electrical contact means are closed upon pivoting the module casing,
and wherein the pivoting means, designed on the module casing, are mounted in the steering wheel foam of the steering wheel.

2. The steering wheel according to claim 1, wherein the pivoting means are designed on the module casing on its lower side, which is turned away from a driver, and are mounted in the steering wheel foam.

3. The steering wheel according to claim 1, wherein the pivoting means allow for a pivoting movement of the module casing along exactly one swivel axis.

4. The steering wheel according to claim 1, wherein the pivoting means are formed by at least two fastening elements, lying on an axis and spaced apart from each other, which can be rotated around this axis in the steering wheel foam.

5. The steering wheel according to claim 4, wherein the pivoting means are formed by at least two elements of the module casing, which can be connected lockable to the steering wheel foam.

6. The steering wheel according to claim 1, wherein the steering wheel foam forms at least one bearing housing for mounting the pivoting means.

7. The steering wheel according to claim 1, wherein the pivoting means are mounted in the area of at least one spoke in the steering wheel foam.

8. The steering wheel according to claim 1, wherein the pivoting means are mounted in the area of the steering wheel hub in the steering wheel foam.

9. The steering wheel according to claim 1, wherein the steering wheel foam has a separate foam part for mounting the pivoting means.

10. The steering wheel according to to claim 3, wherein the fastening means have at least two fastening pins, arranged along an axis which runs parallel to the swivel axis.

11. The steering wheel according to claim 1, wherein the fastening means can be locked in place with the steering wheel.

12. The steering wheel according to claim 1, wherein for the floating bearing of the module casing on the steering wheel at least one spring element is provided, which rests between the module casing and the steering wheel hub and which provides a spring force loaded tolerance for the movement of the module casing relative to the steering wheel.

13. The steering wheel according to claim 1, wherein the module cover is rigidly connected to the module casing, but not to other parts of the vehicle steering wheel.

14. The steering wheel according claim 1, wherein the pivoting means are formed by protrusions designed in one piece on the module casing.

15. The steering wheel according to claim 1, wherein the pivoting means are mounted in the steering wheel foam via snap fits.
